(19) United States
(12) Patent Application Publication
(10) Pub. No.: US 2011/0030183 A1
(43) Pub. Date: Feb. 10, 2011

(54) JIG AND FIXTURE FOR WIND TURBINE BLADE

(75) Inventors: Jamie T. Livingston, Simpsonville, SC (US); William B. Holmes, Anacortes, WA (US); Fred Smethers, Sedro Woolley, WA (US); Edward West, Bellingham, WA (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/907,510

(22) Filed: Oct. 19, 2010

Related U.S. Application Data
(62) Division of application No. 11/854,867, filed on Sep. 13, 2007.

(51) Int. Cl. B25B 11/02

(52) U.S. Cl. 29/281.3; 29/281.1

(57) ABSTRACT

A method and apparatus for assembling a wind turbine blade includes a jig and fixture for positioning one of a leading edge section of the blade and a trailing edge section of the blade over at the other of the leading edge section and the trailing edge section, and for securing the leading edge section to the trailing edge section.

### BACKGROUND OF THE INVENTION

1. Technical Field

The subject matter described here generally relates to fluid reaction surfaces with a specific blade structure formed with a main spar, and, more particularly to a method and apparatus for assembling a wind turbine blade with a jig and fixture.

2. Related Art

A wind turbine is a machine for converting the kinetic energy in wind into mechanical energy. If the mechanical energy is used directly by the machinery, such as to pump water or to grind wheat, then the wind turbine may be referred to as a windmill. Similarly, if the mechanical energy is converted to electricity, then the machine may also be referred to as a wind generator or wind power plant.

Wind turbines use an airfoil in the form of a “blade” to generate lift and capture momentum from moving air that is them imparted to a “rotor.” The blade is typically secured to the rotor at its “root” end, and then extends radially “outboard” to a free, “tip” end. The distance from the tip to the root is referred to as the “span.” The front, or “leading edge,” of the blade connects the forward-most points of the blade that first contact the air. The rear, or “trailing edge,” of the blade is where airflow that has been separated by the leading edge rejoins after passing over the opposite “suction” and “pressure” surfaces of the blade. A “chord” line connects the leading and trailing edges of the blade in the direction of the typical airflow across the blade. Many wind turbine blades also have a stiffening “spar” running the span length of the blade for adding rigidity to the blade. This spar is often configured as an I-beam or C-channel beam; however, other structural configurations may also be used.

Since the installed power of a wind turbine is proportional to the length of the blades, the length of many modern wind turbine blades has increased to over 70 meters. Such long blades can be so difficult to transport that specialized logistic systems have been proposed, such as those in U.S. Patent Publication No. 2006/285937 and WIPO Patent Publication No. WO2006/061806. Other approaches have relied upon modular wind turbine blade configurations that can be manufactured and/or shipped in smaller pieces which can then be assembled at a construction site, such as those disclosed in U.S. patent application Ser. No. 11/380936 filed on Apr. 30, 2006 as “Modular Rotor Blade For A Wind Turbine And Method For Assembling Same” (Attorney Docket No. 196356); and U.S. patent application Ser. No. 11/311,053 filed on Dec. 19, 2005 as “A Modularly Constructed Rotorblade and Method for Construction” (Attorney Docket Nos. 180916 and 182704). Nonetheless, the manufacture, transport, and/or assembly of wind turbine blade sections can still be further improved.

### BRIEF DESCRIPTION OF THE INVENTION

These and other aspects of such conventional approaches are addressed here by providing, in various embodiments, a method of assembling a wind turbine blade, including the steps of and/or for positioning one of a leading edge section of the blade and a trailing edge section of the blade over at the other of the leading edge section and the trailing edge section; and securing the leading edge section to the trailing edge section. Also disclosed is an apparatus for assembling a wind turbine blade, including a fixture for supporting a first section of the wind turbine blade; and a jig for supporting a second section of the wind turbine blade over the fixture; wherein the jig and fixture engage for positioning the second section on the first section as the jig is lowered over the fixture.

### BRIEF DESCRIPTION OF THE DRAWINGS

Various aspects of this technology invention will now be described with reference to the following figures (“FIGS.”) which are not necessarily drawn to scale, but use the same reference numerals to designate corresponding parts throughout each of the several views.

FIG. 1 is an exploded orthographic view of a jig and fixture for a wind turbine blade.

FIG. 2 is an assembled orthographic view of the jig and fixture for a wind turbine blade from FIG. 1.

FIG. 3 is an exploded orthographic view of the fixture for a wind turbine blade from FIG. 1 with a leading edge section of the blade.

FIG. 4 is another orthographic view of the fixture for a wind turbine blade shown in FIG. 3.

FIG. 5 is a partially exploded orthographic view of the fixture for a wind turbine blade illustrated from FIG. 3 with another leading edge section of the blade.

FIG. 6 is another orthographic view of the fixture for a wind turbine shown in FIG. 5.

FIG. 7 is an exploded orthographic view of the fixture for a wind turbine blade shown on the FIG. 6 with a section of the spar.

FIG. 8 is another orthographic view of the fixture for a wind turbine blade shown in FIG. 7.

FIG. 9 is a partially assembled orthographic view of the fixture for a wind turbine blade shown in FIG. 7 with a section of the spar.

FIG. 10 is another orthographic view of the fixture for a wind turbine blade shown in FIG. 9.

FIG. 11 is an exploded orthographic view of the jig for a wind turbine blade from FIG. 1 with a trailing edge section of the blade.

FIG. 12 is an enlarged, partial end view of the jig for a wind turbine blade shown in FIG. 1.

FIG. 13 is an enlarged, partial orthographic view of the assembled jig and fixture for a wind turbine blade shown in FIG. 2.

FIG. 14 is an enlarged, partial end view of the assembled jig for a wind turbine blade shown in FIG. 2.

FIG. 15 is another enlarged, partial end view of the assembled jig for a wind turbine blade shown in FIG. 2.

FIG. 16 is an another enlarged, partial end view of the assembled fixture for a wind turbine blade shown in FIG. 2.

### DETAILED DESCRIPTION OF THE INVENTION

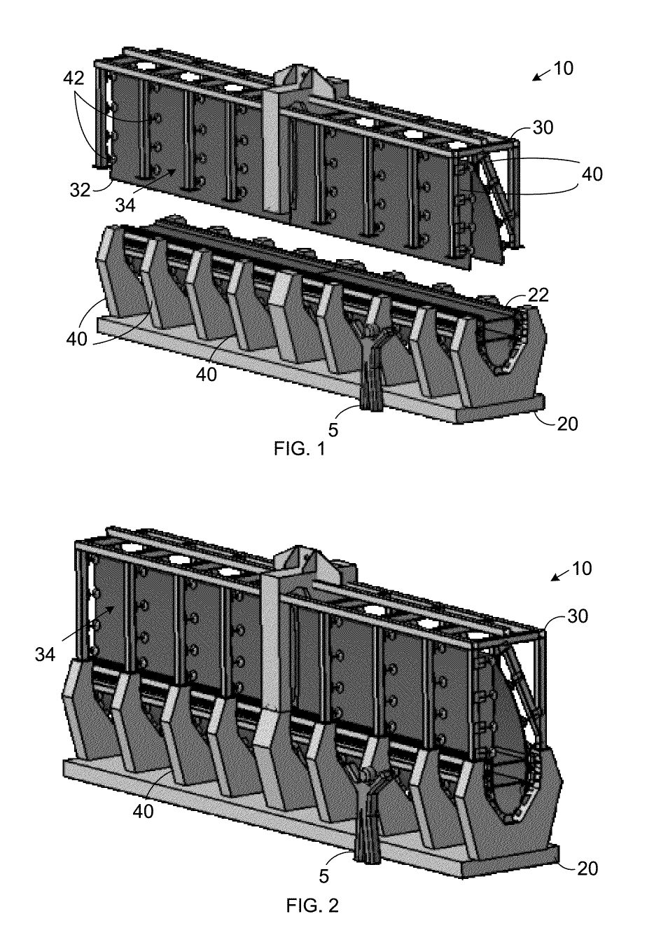

FIG. 1 is an exploded orthographic view of a jig and fixture apparatus 10 for assembling a wind turbine blade while FIG. 2 is an assembled orthographic view of the jig and fixture apparatus 10 from FIG. 1. In broad terms, a fixture is generally a device that is used to hold an object in place so that a tool or other component can be moved in relation to the stationary object. A jig, on the other hand, generally holds the object and guides it in relation to a fixed tool or other component.

In FIGS. 1 and 2, the stationary fixture 20 supports a leading edge section 22 of a wind turbine blade while the moveable jig 30 supports a trailing edge section 32 of the wind turbine blade. In the examples illustrated here, the leading edge section 22 includes a curved nose 24, several semi-elliptical nose reinforcement plates 26 (best seen in FIGS. 4, 6, and 8), and a generally rectangular spar 28. However, various other components and/or configurations for the leading edge section 22 may also be used. Similarly, although the trailing edge section 32 that is illustrated here includes a substantially flat high pressure surface 34 and curved low pressure surface 36, various other components and/or configurations for the trailing edge section 32 may also be used. The various wind turbine blade sections 22 and 32 may also be different shapes, larger, and/or smaller than the ones illustrated here. The human figure 5 shown in several of these drawings merely illustrates the relatively large size of various exemplary embodiments discussed in more detail below.

In these Figures, the moveable jig 30 is arranged and positioned over the stationary fixture 20. For example, the jig 30 may be lifted over the fixture 20 using a crane, forklift, or other lifting mechanism. However, the positions of the jig 30 and fixture 20 may also be reversed. Similarly, the fixture 20 may be moveable and/or the jig 30 may be stationary. Likewise, the fixture 20 may alternatively be configured to support the trailing edge section 32 while the jig 30 is configured to support the leading edge section 22. Arranging the fixture 20 over the jig 30, or vice versa, in a generally vertical configuration, helps minimize dimensional distortion due to the effects of gravity on unsupported surfaces which can otherwise adversely affect the assembly process as described in more detail below. The vertical configuration also aids with aligning the leading edge section 22 with the trailing edge section 32 before these components are joined together.

Some or all of the wind turbine blade assembly process may be performed at the site where the wind turbine is located. For example, the leading and trailing edge sections 22 and 32 may be fitted to the fixture 20 and/or jig 30 at a manufacturing facility before being shipped to the remote construction site for securing together as illustrated in FIG. 2 and described in more detail below. This logistical scenario allows multiple, smaller sections of a wind turbine blade to be pre-loaded on the fixture 20 and/or jig 30 so that they can be more easily transported to the construction site before final assembly. In this way, the fixture 20 and/or jig 30 helps to protect the blade sections 22 and/or 32 during loading, transport, unloading, and final assembly.

Each of the illustrated fixture 20 and jig 30 includes a plurality of generally U-shaped or V-shaped arms 40 generally corresponding to an exterior surface of the corresponding blade section 22 or 30. Each of the arms includes one or more fasteners 42 for releasably securing the corresponding leading edge section 22 or trailing edge section 32 as described in more detail below. For example, the fasteners 42 may include suction cups.

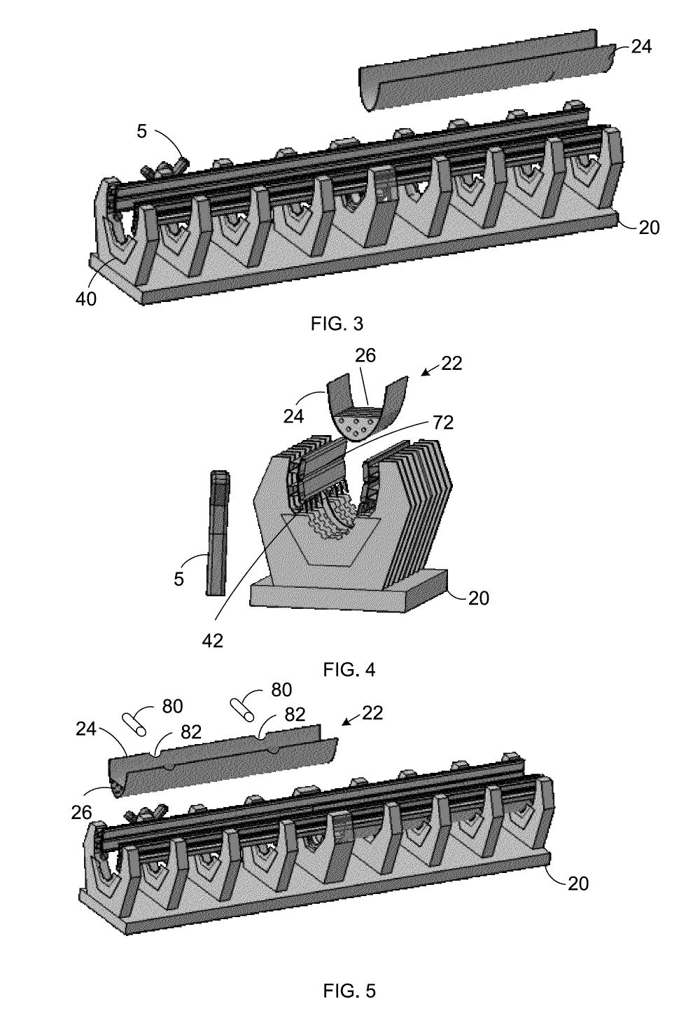

FIG. 3 is an exploded orthographic view of the fixture 20 for a wind turbine blade from FIG. 1 with a portion of a leading edge section 22 of the blade. FIG. 4 is another orthographic view of the fixture for a wind turbine blade shown in FIG. 3. In FIGS. 3 and 4, the leading edge portion 22, is being lowered into and arranged in the fixture 20. Although the illustrated first leading edge portion is a nose portion 24 with nose reinforcement plates 26 (FIG. 4), other wind turbine blade components may also be used. For example, some or all of the nose reinforcement plates 26 may be replaced by a core material in order to enhance stiffness. For the illustrated example, the nose reinforcement plates 26 may be fitted into the curved nose portion 24 before or after the nose portion is positioned or loaded in the fixture 20.

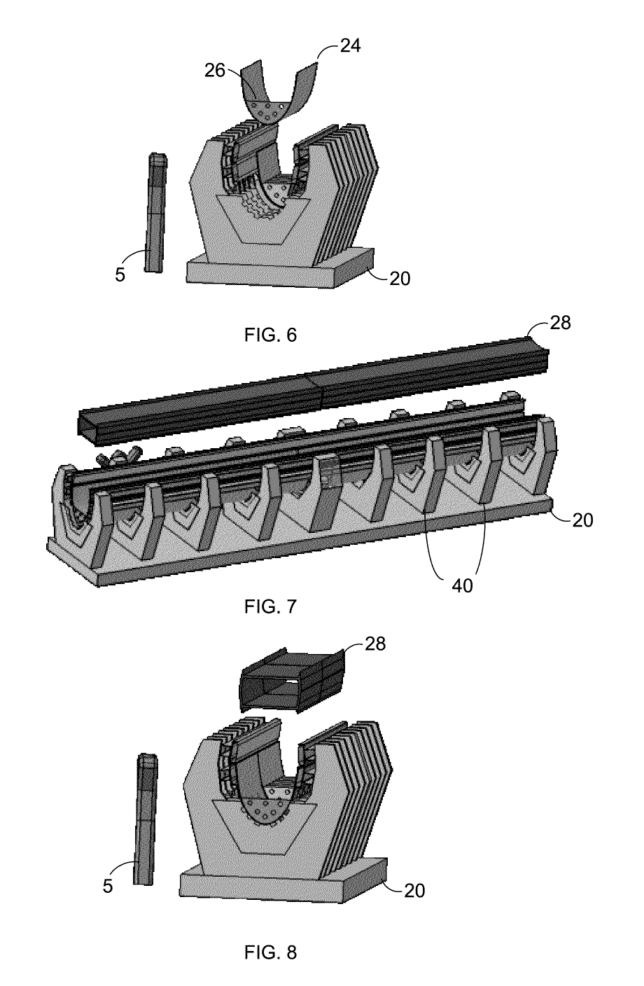

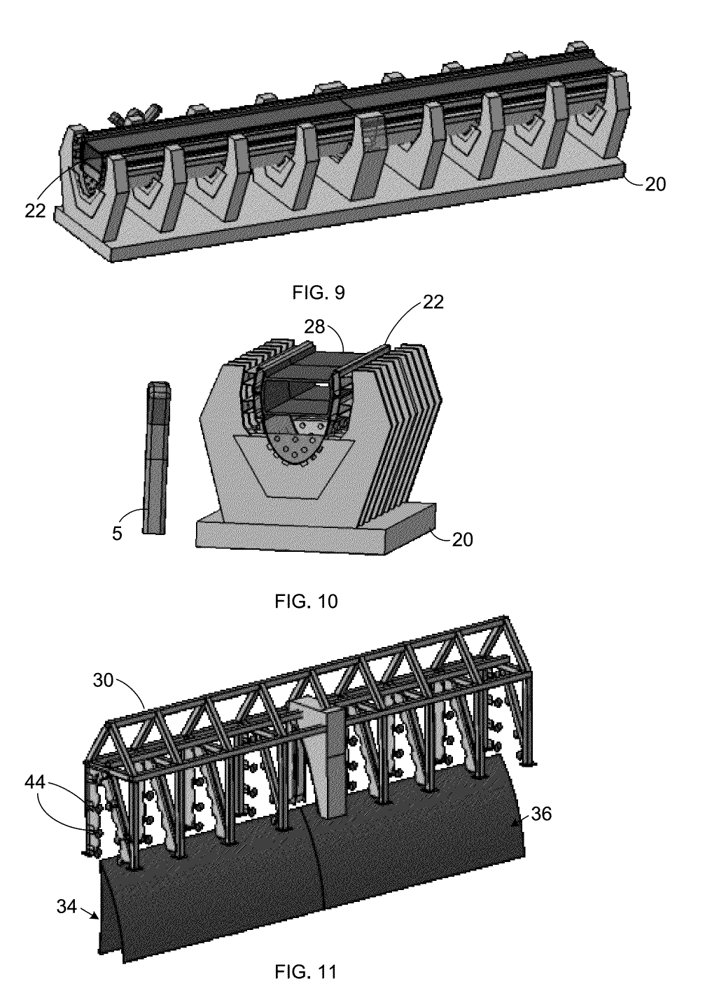

In FIGS. 5 and 6 a second portion of a leading edge section 22 is being arranged in the fixture 20 and end-to-end with the first leading edge portion already in the fixture 20. Although the illustrated leading edge section 22 is formed from two nose portions 24 that are arranged end-to-end in a single fixture 20, a single-piece leading edge section 22 and/or other components may also be used. Some or all of the adjacent, joining surfaces of the leading edge section 22 and the spar 28 are provided with a fastening medium such as glue, resin, or other adhesive for securing the various components together. However, the various components of the blade may also be secured together in another fashion. FIG. 5 also illustrates one example of spar supports 80 being arranged in notches 82 formed in the upper edge of one of the leading edge sections 22 for supporting the spar 28 in the leading edge section 22. However, the spar 28 may also be supported in other ways such as by supports formed in the leading edge section 22. Once the leading edge section 22 is arranged in the fixture 20, a single-piece or multi-piece spar 28 is arranged in the nose portions 24 as illustrated in FIGS. 7 and 8.

The complete leading edge section 22 arranged in the fixture 20 is illustrated in FIGS. 9 and 10, ready for transporting to a construction site as discussed above. In this way, a long blade can be shipped in multiple, shorter pieces which are easier to transport to a wind turbine installation. Once a loaded fixture 20 and jig 30 arrive at the wind turbine installation, they can be joined in the vertical configuration shown in FIGS. 1 and 2. Alternatively, the leading edge section 22 and/or trailing edge section 32 may be shipped to the installation separate from their corresponding jig 10 and or fixture 20 and then loaded into the jig and/or fixture at the installation. Additional leading and/or trailing edge sections 22, 32 arranged in their jigs 10 and fixtures 20 can then also be joined end-to-end with other sections in order to complete the fabrication of the blade at the installation site, rather than transporting the much longer and larger, fully-assembled blade in a single shipment.

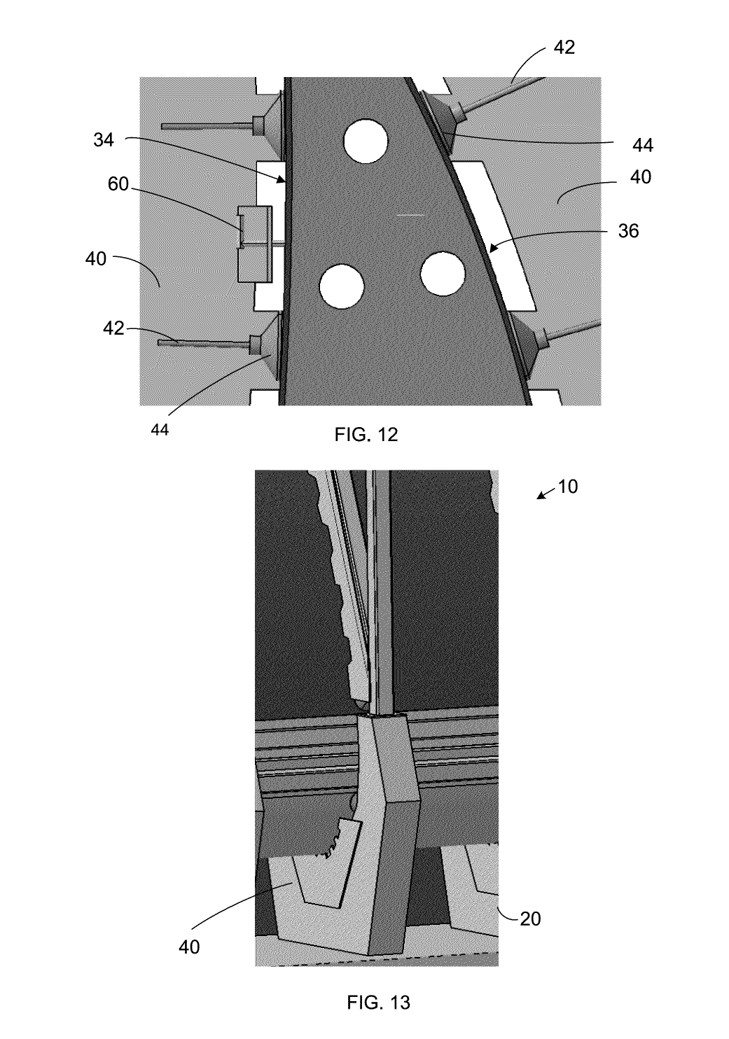

FIG. 11 is an exploded orthographic view of the jig 30 from FIG. 1 with a trailing edge section 32 of the blade. In FIG. 11, the trailing edge section 32 is being arranged between U-shaped or V-shaped arms 40. Each of the arms 40 includes a plurality of fasteners 42 for securing the trailing edge section 32 to the jig 30. For example, as illustrated in the enlarged end view of FIG. 12, the fasteners 42 may include pneumatic suction devices 44 for releasably securing with an external surface of the trailing edge section 32. However, a variety of other pneumatic and non-pneumatic devices may also be used to releasably secure the leading edge section 22 or trailing edge section 32 to the corresponding fixture 20 or jig 30.

FIG. 13 is an enlarged, partial orthographic view of the assembled jig 30 and fixture 20 for a wind turbine blade shown in FIG. 2. FIG. 13 illustrates one side of one U-shaped arm 40 of the jig 30 extending into a guide opening in the top of a U-shaped arm 40 of the fixture 20 for aligning and positioning the jig relative to the fixture. This configuration also allows for a rough alignment of the trailing edge section 32 with the leading edge section 22. Alternatively, an arm 40 of the fixture 20 may extend into an arm 40 of the jig 30. Once the jig 30 and fixture 20 are roughly aligned in this, or any other, manner, a finer alignment may be performed by moving edge section 22 and/or 32 relative to the fixture 22 or jig 30. In this regard, one or both of the jig 30 and fixture 30 may be provided with an indexer 60 (shown in FIG. 12) for finely positioning the edge section 22 and 32 relative to each other in a spanwise direction before they are secured together. The fixture 20 may also be provided with leveling feet, shims, and/or systems for other leveling the leading edge section 22 relative to the ground, the trailing edge section 32, and/or the other leading/training edge sections which are arranged end-to-end.

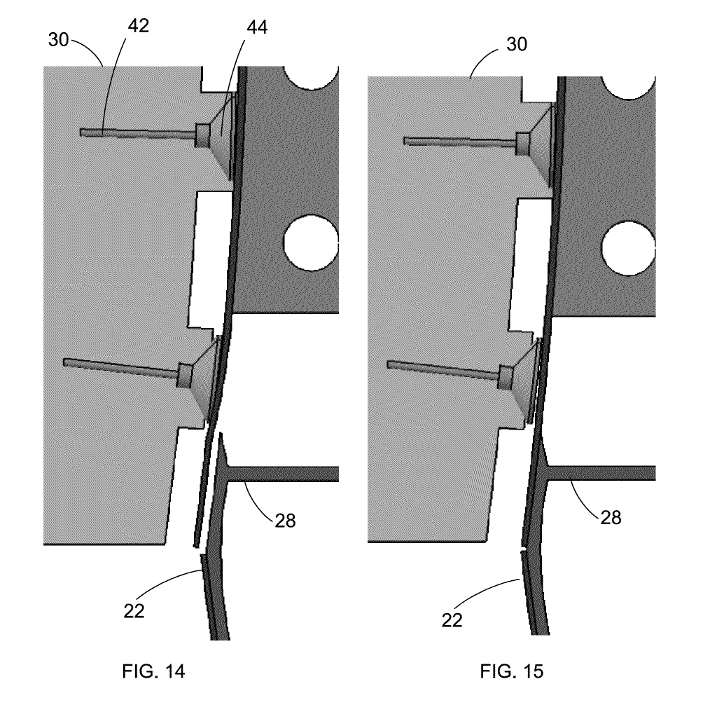

FIGS. 14 and 15 are other enlarged, partial end views of the jig 30 for a wind turbine blade shown in FIG. 2 with the leading edge section 22 and the trailing edge section 32. FIG. 14 illustrates the suction cup 44 of the lower fastener 42 of the jig 30 engaged with the external skin of the trailing edge section 32, and being pulled toward the jig 30 so as to expand the spanwise opening of the trailing edge section 32 around the spar 28. In FIG. 15, the lower fastener 42 is repositioned or released in order to allow the opening of the trailing edge section 32 to close against the side of the spar 28. A similar technique may be used with the leading edge 22 section for receiving the spar 28.

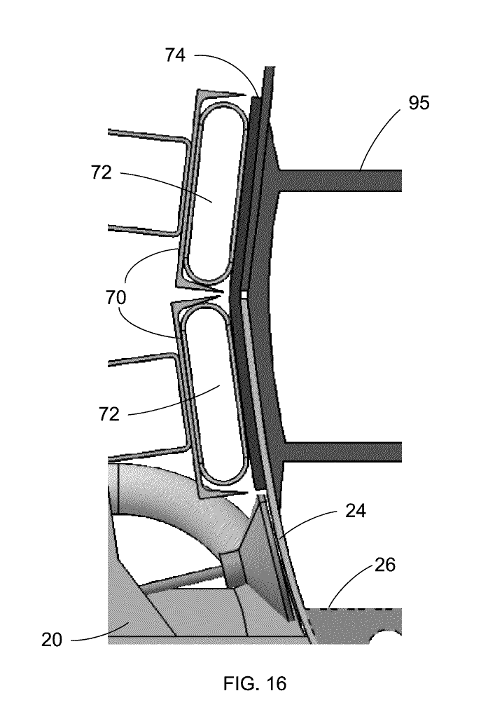

Some or all of the adjacent, joining surfaces of the trailing edge and leading edge section 22 and 32, and/or the spar 28, may be provided with a fastening medium such as glue, resin, or other adhesive for securing the various components together. However, the various components of the blade may also be secured together in another fashion. Once the trailing edge and leading edge sections 32 and 22 are in place against the spar 28, they may also be compressed against the spar. For example, as illustrated in the enlarged, partial end view of the assembled fixture in FIG. 16, one or more presses 70 may extend from the fixture 20 and/or jig 30 (not shown) for compressing the openings of the leading and trailing edge sections 22 and 32 against the spar 28. In FIG. 16, separate presses 70 extend from each of the fixture 20 and jig 30 with bladders 72 for protecting the surface of the assembled blade. In addition, a heated or unheated caul plate 74 may be arranged between the presses 70 and the blade for maintaining even pressures and/or temperatures on the bonding surfaces of the leading and trailing edge sections 22 and 32.

The previously described embodiments offer various advantages over conventional approaches. For example, loading the edge sections 22 and 32 onto the jig 20 and fixture 30 prior to shipment allows the blade to be shipped in smaller, protected pieces that can be assembled relatively easily at a wind turbine construction site. In addition, the vertical alignment of the jig 30 and fixture 20 allows the leading and trailing edge sections 22 and 32 to be more easily and accurately positioned before having their spanwise openings widened for easily fitting around the spar 28.

It should be emphasized that the embodiments described above, and particularly any “preferred” embodiments, are merely examples of various implementations that have been set forth here to provide a clear understanding of various aspects of this technology. It will be possible to alter many of these embodiments without substantially departing from scope of protection defined solely by the proper construction of the following claims.

1. (canceled)

2. (canceled)

3. (canceled)

4. (canceled)

5. (canceled)

6. (canceled)

7. An apparatus for assembling a wind turbine blade, comprising:
a fixture for supporting a first section of the wind turbine blade;
a jig for supporting a second section of the wind turbine blade over the fixture; and
wherein the jig and fixture engage for positioning the second section on the first section as the jig is lowered over the fixture.

8. The apparatus recited in claim 7 wherein the first section of the blade comprises a leading edge section and the second section of the blade comprises a trailing edge section.

9. The apparatus recited in claim 8 wherein at least one of the fixture and the jig comprises:
a plurality of U-shaped arms having a shape generally corresponding to an exterior surface of the supported blade section; and
at least one releasable fastener on each arm for securing the supported blade section to the at least one of the fixture and the jig.

10. The apparatus recited in claim 9 wherein each of the fasteners is moveable for widening a spanwise opening of the supported blade section.

11. The apparatus recited in claim 10 wherein the fasteners comprise suction cups.

12. The apparatus recited in claim 10 wherein at least one of the fixture and the jig further comprises a press for compressing a heated caul sheet against the exterior surfaces of the leading edge section and the trailing edge section.

13. (canceled)

14. (canceled)

15. (canceled)

16. (canceled)

17. (canceled)

18. (canceled)
